(19) United States
(12) Patent Application Publication
(10) Pub. No.: US 2019/0391442 A1
(43) Pub. Date: Dec. 26, 2019

(54) DISPLAY APPARATUS

(71) Applicant: SAKAI DISPLAY PRODUCTS CORPORATION, Osaka (JP)

(72) Inventor: YASUYUKI AIKAWA, Osaka (JP)

(21) Appl. No.: 16/362,334

(22) Filed: Mar. 22, 2019

(30) Foreign Application Priority Data
Jun. 25, 2018 (JP) 2018-120013

(51) Int. Cl. G02F 1/1333; G02F 1/1345

(52) U.S. Cl. CPC G02F 1/133308; G02F 1/13452

(57) ABSTRACT

A display apparatus according to an embodiment of the present invention includes: a display panel having a front surface that includes a display screen and a peripheral region located around the display screen; a panel chassis holding the peripheral region of the display panel from an opposite side of the front surface, the panel chassis having a side surface which is substantially orthogonal to the front surface; a bezel covering the peripheral region of the display panel and the side surface of the panel chassis; and a plurality of driving circuits connected to the peripheral region of the display panel. The plurality of driving circuits include a driver IC which is COF-mounted on a film substrate. The film substrate has a first side edge and a second side edge opposite to the first side edge, the film substrate being bent so that the first side edge is located in the peripheral region and that the second side edge is located above the side surface of the panel chassis. The bezel has at least one aperture opposed to a portion of the second side edge of the film substrate.

### BACKGROUND

### 1. Technical Field

The present invention relates to a display apparatus including a display panel which has a display screen, such that a COF (Chip On Film) for driving the display panel is connected to an edge of the display panel, and that a bezel accommodates the display panel with the COF being bent.

### 2. Description of the Related Art

In a display apparatus that includes a liquid crystal panel, an organic EL (Electroluminescence) panel, etc., as its display panel, a driving circuit to drive the display panel may be COF (Chip On Film)-mounted on a film substrate, as a driver IC, for example (see, e.g., Japanese Patent No. 5412821).

### SUMMARY

According to a study by the inventor, there is a possibility that a display apparatus having a driving circuit which is COF-mounted on a film substrate may not properly operate. Details thereof will be described later.

The present invention has been made in view of the above circumstances, and an objective thereof is to easily avoid malfunctioning of a driving circuit in a display apparatus, where the driving circuit is COF-mounted.

A display apparatus according to the present invention includes: a display panel having a display screen; a COF (Chip On Film) that is connected to an edge of the display panel and drives the display panel; and a bezel which circumscribes the display screen and accommodates the display panel while the COF is bent toward the opposite side relative to the display screen, such that the bezel has a peep hole at a position opposed to the bent end of the COF.

In this display apparatus, the COF that drives the display panel is connected to an edge of the display panel, and, while the COF is bent toward the opposite side relative to the display screen, the bezel circumscribes the display screen and accommodates the display panel. Since a peep hole is provided in the bezel at a position opposed to the bent end of the COF, so that the bent end of the COF is viewable, it is possible to easily confirm that the COF is accommodated in an appropriate position and state.

With a display apparatus according to the present invention, malfunctioning of a driving circuit in the display apparatus, where the driving circuit is COF-mounted, can be easily avoided.

### BRIEF DESCRIPTION OF THE DRAWINGS

FIG. 1 is an explanatory diagram showing an example of an appropriate position and state of a COF when a display panel is assembled with a bezel being placed thereon.

FIG. 2 is an explanatory diagram showing an example of an inappropriate position and state of a COF when a display panel is assembled with a bezel being placed thereon.

FIG. 3 is a perspective view showing an exemplary appearance of a display apparatus.

FIG. 4 is an exploded perspective view showing an exemplary schematic construction of a display apparatus.

FIG. 5 is a cross-sectional view showing an example where a COF is in a bent state when the display panel is assembled with a bezel being placed thereon.

FIG. 6 is an explanatory diagram showing an example of peep holes, and an appropriate position and state of a COF, when the display panel is to be assembled with a bezel being placed thereon.

FIG. 7 is an explanatory diagram showing an example of a peep hole, and an appropriate position and state of a COF, when the display panel is to be assembled with a bezel being placed thereon, in a display apparatus in which the COF has a shape that is not a right-angled quadrilateral.

FIG. 8 is an explanatory diagram showing an example of a peep hole, and an appropriate position and state of a COF, when the display panel is to be assembled with a bezel being placed thereon, in another display apparatus in which the COF has a shape that is not a right-angled quadrilateral.

### DETAILED DESCRIPTION

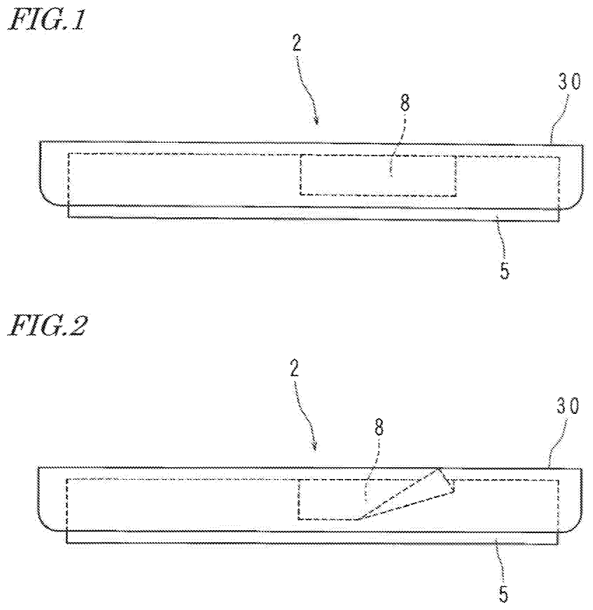

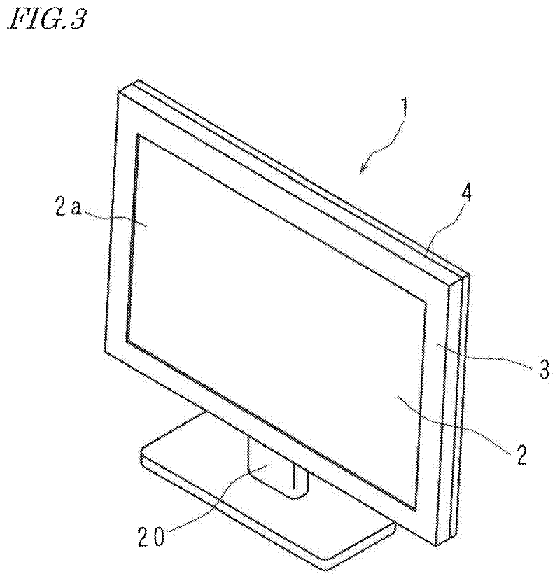

First, in a display apparatus, a cause for malfunctioning of a driving circuit (driver IC) that is COF-mounted will be described with reference to FIG. 1 and FIG. 2. Note that “COF”, which usually refers to a mounting method (mounting technique) with which an IC chip may be mounted on a film substrate, may in the present specification be also a reference to a film substrate having an IC chip mounted thereon.

As COFs, for example, a display apparatus may include a source COF carrying a source driver IC and a gate COF carrying a gate driver IC. Generally speaking, a display apparatus may include a plurality of source COFs and a plurality of gate COFs.

In the case of a source COF, on one side edge of the source COF, terminals for connection with the display panel are disposed next to one another, these terminals being crimped with terminals which are provided at e.g. a lower edge of the display panel. At the other side edge of the source COF opposite to the junction with the display panel, a source substrate is connected.

On the other hand, in the case of a gate COF, on one side edge of the gate COF, terminals for connection with the display panel are disposed next to one another, these terminals being crimped with terminals which are provided at e.g. a right or left edge of the display panel. At the other side edge of the gate COF opposite to the junction with the display panel, nothing is connected.

The display panel is accommodated in a bezel, the bezel being placed onto the display panel from the display screen side and circumscribing the display screen. When the bezel is placed onto the display panel from the display screen side, the gate COF having nothing connected to whose opposite side edge is bent substantially perpendicularly to the display screen, in a manner of following along the inner surface of the bezel, whereby the display apparatus is “narrow-framed”.

In the display apparatus, as shown in FIG. 1, when the display panel 2 held by the panel chassis 5 is assembled with the bezel 30 being placed thereon from the display screen side, the COF 8 is accommodated by being bent along the inner surface of the bezel 30.

However, at this point, the COF 8 may become bent in a manner of curling, as shown in FIG. 2. This may possibly cause disconnection of patterns on the film, disconnection at sites of terminal crimping, etc. Thus, the COF-mounted driving circuit may not properly operate. In the display apparatus shown in FIG. 2, it is not possible to check the state of the COF 8 within the bezel 30 from outside of the bezel 30, and therefore any correction is not made. Thus, the problem of inability of the COF-mounted driving circuit to properly operate cannot be easily avoided.

The present invention has been made in view of the above circumstances, and an objective thereof is to provide a display apparatus such that, when a display panel is assembled with a bezel being placed thereon, it is possible to confirm that a COF which is connected to the display panel is accommodated in an appropriate position and state.

As will be described below, according to an embodiment of the present invention, a display apparatus is realized such that, when a display panel is assembled with a bezel being placed thereon, it can be easily confirmed that a COF which is connected to the display panel is accommodated in an appropriate position and state.

Hereinafter, the present invention will be described with reference to drawings illustrating Examples thereof.

### Example 1

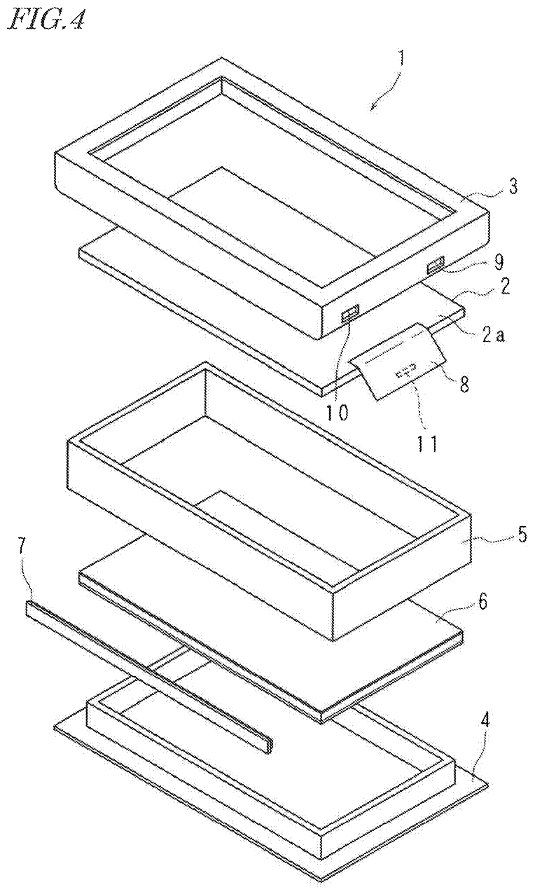

FIG. 3 is a perspective view showing an exemplary appearance of a display apparatus, and FIG. 4 is an exploded perspective view showing an exemplary schematic construction of the display apparatus.

The display apparatus 1 includes: a display panel 2 having a front surface that includes a display screen 2a and a peripheral region located around the display screen 2a; a panel, chassis 5 holding the peripheral region of the display panel 2 from an opposite side of the front surface, the panel chassis 5 having a side surface which is substantially orthogonal to the front surface; a bezel 3 covering the peripheral region of the display panel 2 and the side surface of the panel chassis 5; and a plurality of driving circuits connected to a plurality of terminals which are formed in the peripheral region of the display panel 2. The plurality of driving circuits include a driver IC 11 which is COF-mounted on a film substrate 8. The film substrate 8 has a first side edge and a second side edge opposite to the first side edge, the film substrate 8 being bent so that the first side edge is located in the peripheral region and that the second side edge is located above the side surface of the panel chassis 5. The bezel 3 has at least one aperture (e.g., two apertures herein) 9 and 10 opposed to a portion(s) of the second side edge of the film substrate 8.

Note that the “first side edge” and the “second side edge” are not limited to each being a single line segment (straight line), but may include a plurality of linear portions, or include a curved portion(s).

In this example, the film substrate 8 has a gate driver IC (gate-driving circuit) 11 mounted thereon, the gate driver IC 11 supplying scanning signal voltages to gate bus lines which are formed in the display screen 2a of the display panel 2. The first side edge of the film substrate 8 is connected to the peripheral region of the display panel 2, whereas the second side edge of the film substrate 8 is not connected to any other printed circuit board (FPC) (i.e., free-ended). In other words, the gate driver IC 11 mounted on the film substrate 8 is connected via the first side edge of the film substrate 8 to the plurality of terminals being formed in the peripheral region of the display panel 2. Control signals (e.g., a clock signal, a horizontal sync signal) to control the gate driver IC 11 are supplied to the gate driver IC 11 via a plurality of interconnects which are formed in the peripheral region of the display panel 2.

The display apparatus 1 further includes, for example, a source driver IC (source-driving circuit) to supply display signal voltages to source bus lines which are formed in the display screen 2a of the display panel 2, and a control circuit to control the source driver IC. From the control circuit to the source driver IC, a control signal (e.g., a clock signal) to control the source driver IC is supplied. The source driver IC is mounted on a source COF (film substrate), whereas the control circuit is mounted on the source substrate. The source COF has a first side edge and a second side edge opposite to the first side edge, the first side edge being connected to the peripheral region of the display panel 2, and the second side edge being connected to the source substrate. In other words, the source driver IC mounted on the source COF is connected via the first side edge of the film substrate to the plurality of terminals formed in the peripheral region of the display panel 2, and connected via the second side edge to the control circuit mounted on the source substrate.

The display apparatus 1, which may be e.g. a liquid crystal display apparatus, is supported by a foot 20 that is provided under the display panel (liquid crystal panel) 2. The periphery of the display panel 2 is covered by the bezel 3 and a front cabinet, each of which constitutes a frame member, whereas the rear surface of the display panel 2 is covered by a backlight chassis (hereinafter referred to as the BL chassis) 4 and a back cabinet.

As shown in FIG. 4, the display apparatus 1 is composed by stacking the bezel 3, the display panel 2, the panel chassis 5, a light guide plate 6 and a light source section 7, and the BL chassis 4 in this order. The display panel 2 has a rectangular display screen (displaying region) 2a to display an image. The bezel 3, which is a rectangular frame made of a metal, includes plate members that protrude perpendicularly from the outer periphery and circumscribe the periphery of the display screen 2a of the display panel 2.

At the right edge of the peripheral region of the display panel 2, a rectangular COF (Chip On Film) 8 carrying an IC chip 11, having a gate driver IC for driving the display panel 2, is connected. The COF 8 is a gate COF which supplies a scanning signal to the display panel 2. On one side edge (first side edge) of the COF 8, terminals for connection with the display panel 2 are disposed next to one another, these terminals being crimped with terminals which are provided at an edge of the display panel 2. The side edge (second side edge) of the COF 8 that is not connected to the display panel 2 is connected to nothing.

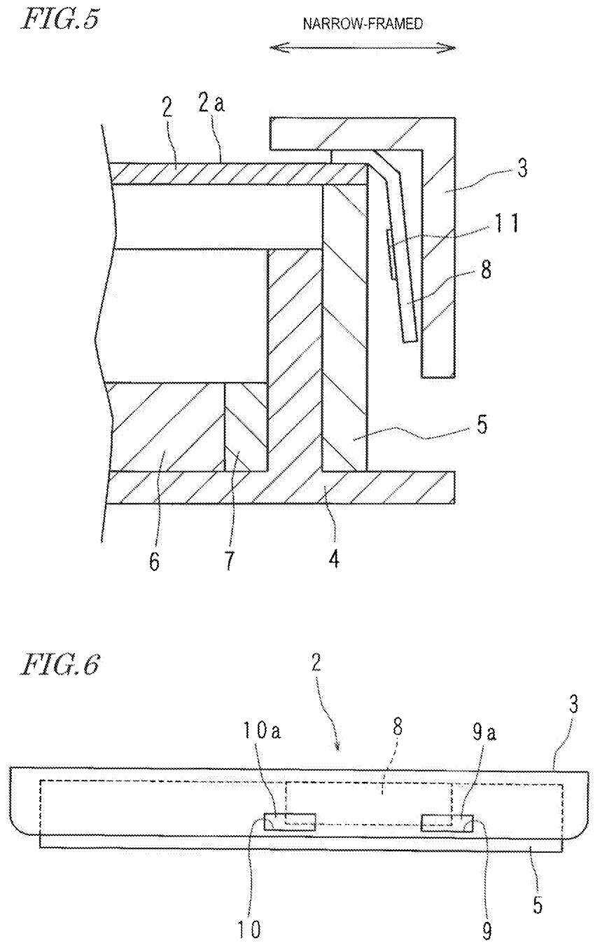

When the display panel 2 is assembled with the bezel 3 being placed thereon from the display screen 2a side, as illustrated in the cross-sectional view of FIG. 5, the COF 8 is bent by substantially 90 degrees toward the opposite side relative to the display screen 2a, in a manner of following along the inner surface of the bezel 3, and thus is accommodated in the bezel 3.

A right side plate of the bezel 3 has two peep hole (apertures) 9 and 10 made therein, at two positions opposed to two ends of the COF 8 which is to be accommodated by being bent. Through the peep holes 9 and 10, the two ends of the COF 8 to be accommodated can be individually viewed. The size of the peep holes 9 and 10 is preferably small; if their size is increased without due care, deterioration in terms of strength, or twisting, of the bezel 3 might be caused. In the case where the COF 8 has a rectangular shape, it is preferable to provide peep holes 9 and 10 at (two) positions where both ends of the bent portion of the COF 8 can be checked. In other words, in the case where the film substrate 8 is a right-angled quadrilateral (which encompasses a rectangle and a square), the bezel 3 preferably has two apertures 9 and 10 that are opposed to both ends of the second side edge. This will make it possible to check the state in which the COF 8 is accommodated; and their size may each be the smallest size that permits viewing of the tip of the end, although assembly variations must be accounted for.

The panel chassis 5 is a rectangular frame of resin, which is formed so as to be somewhat smaller than the bezel 3 and accommodated in the bezel 3, holds the display panel 2 from the rear surface and from around. The light guide plate 6 is made of a synthetic resin with high transparency, such as acrylic resin or polycarbonate resin, and is made into a rectangular plate. The light guide plate 6 has an optical sheet attached on a surface that is opposed to the display panel 2, and a reflection sheet attached on the rear surface (i.e., a surface opposed to the BL chassis 4), so that light from the light source section 7 that strikes through the end surface opposed to the light source section 7 will equally and uniformly shine on the rear surface of the display panel 2.

The light source section 7 has a plurality of light sources mounted on an elongated strip-shaped substrate. The light sources may be e.g. light emitting diodes (LED), which are mounted next to one another along the longitudinal direction of the substrate. The BL chassis 4 is a metal member having a rectangular dish shape, having a flange provided around its opening section, the flange protruding outwardly. The outer dimensions of the flange of the BL chassis 4 are substantially equal to the outer dimensions of the panel chassis 5.

The display apparatus 1 is constructed by: disposing the light guide plate 6 on the bottom plate of the BL chassis 4, and the light source section 7 on a side plate thereof, placing the panel chassis 5 thereon, disposing the display panel 2 on the panel chassis 5, placing the bezel 3 thereon, and fastening together the bezel 3, the panel chassis 5, and the BL chassis 4 by using fastening members not shown.

In the display apparatus 1 of such construction, as shown in FIG. 6, when the display panel 2 is assembled with the bezel 3 being placed thereon from the display screen 2a side, the COF 8 is to be accommodated by being bent along the inner surface of the bezel 3. At this time, if the COF 8 is accommodated by being properly bent and without being curled, then the two ends of the COF 8 can be viewed respectively through the two peep holes 9 and 10 as shown in FIG. 6, whereby it can be confirmed that the COF 8 is properly accommodated.

On the other hand if the COF 8 is accommodated in a curled, abnormally bent state, then the two ends of the COF 8 cannot be viewed through the two peep holes 9 and 10. In this case, a correction can be made by assembling the display panel 2 and the bezel 3 again.

By sealing the peep holes 9 and 10 with transparent members 9a and 10a such as a resin or glass, as shown in FIG. 6, dust can be prevented from intruding into the display apparatus 1. When the transparent members are resin tape, the peep holes 9 and 10 can be easily sealed.

This Example has illustrated a case where the COF 8 is connected to the right edge of the display panel 2. Depending on the model, however, a construction where a gate COF (whose opposite side edge is connected to nothing) is connected at the left of the display panel, or a construction where such gate COFs are connected at both the right and left of the display panel, may be possible, for example. Also in such cases, the bezel may have peep holes at positions opposed to the bent ends of the COF, whereby similar effects can be obtained. The present invention is applicable without any limitations as to the number of COFs or their positions of connection. Moreover, a driver IC to be mounted on the film substrate 8 is not limited to a gate driver IC.

### Example 2

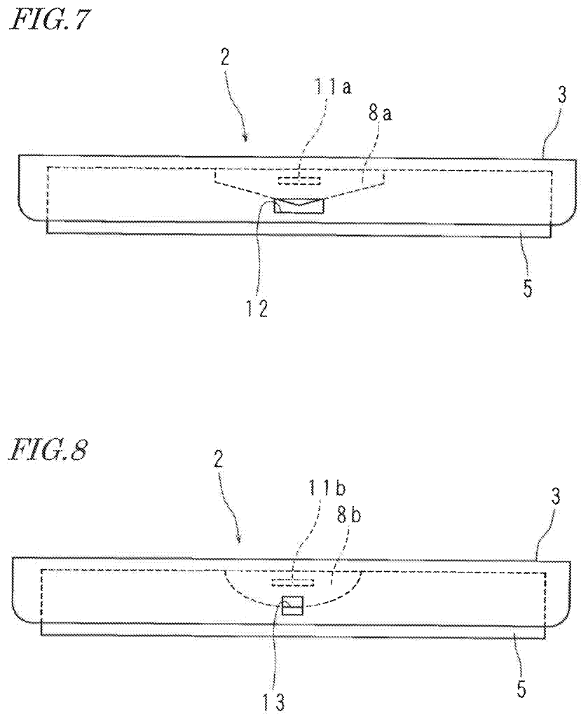

FIG. 7 is an explanatory diagram showing an example of a peep hole, and an appropriate position and state of a COF, when the display panel is to be assembled with a bezel being placed thereon, in a display apparatus in which the COF has a shape that is not a right-angled quadrilateral. In this display apparatus, the COF 8a carrying the IC chip 11a is pentagonal, and when the display panel 2 held by the panel chassis 5 is assembled with the bezel 3 being placed thereon from the display screen side, the COF 8a is to be accommodated by being bent along the inner surface of the bezel 3. In this example, the second side edge of the COF 8a includes a plurality of line segments (linear portions).

At this time, if the COF 8a is accommodated by being properly bent and without being curled, such that the pointed leading end of the bent side of the COF 8a is viewable through one peep hole 12 as shown in FIG. 7, it can be confirmed that the COF 8a is properly accommodated. Otherwise, the construction and operation of this display apparatus are similar to the construction and operation described in Example 1, and the description thereof will be omitted.

### Example 3

FIG. 8 is an explanatory diagram showing an example of a peep hole, and an appropriate position and state of a COF, when the display panel is to be assembled with a bezel being placed thereon, in another display apparatus in which the COF has a shape that is not a right-angled quadrilateral. In this display apparatus, the bent portion of the COF 8b carrying the IC chip 11b has an arc shape, and when the display panel. 2 held by the panel chassis 5 is assembled with the bezel 3 being placed thereon from the display screen side, the COF 8b is to be accommodated by being bent along the inner surface of the bezel 3. In this example, the second side edge of the COF 8b includes a curved portion.

At this time, if the COF 8b is accommodated by being properly bent and without being curled, such that the end of the COF 8b presenting an arc shape is viewable through one peep hole 13 as shown in FIG. 8, it can be confirmed that the COF 8b is properly accommodated. Otherwise, the construction and operation of this display apparatus are similar to the construction and operation described in Example 1, and the description thereof will be omitted.

Examples 1, 2 and 3 of the present specification should in all aspects be considered illustrative, rather than restrictive. It is intended that the scope of the present invention is indicated by the claims, rather than by the above description, and encompasses any and all possible modifications within the meaning and equivalents of the claims.

The present application is based on Japanese Patent Application No. 201.8-120013, which was filed on Jun. 25, 2018, and the entire disclosure thereof is incorporated herein by reference.

What is claimed is:

1. A display apparatus comprising:
a display panel having a front surface that includes a display screen and a peripheral region located around the display screen;
a panel chassis holding the peripheral region of the display panel from an opposite side of the front surface, the panel chassis having a side surface which is substantially orthogonal to the front surface;
a bezel covering the peripheral region of the display panel and the side surface of the panel chassis; and
a plurality of driving circuits connected to the peripheral region of the display panel, wherein,
the plurality of driving circuits include a driver IC which is COF-mounted on a film substrate;
the film substrate has a first side edge and a second side edge opposite to the first side edge, the film substrate being bent so that the first side edge is located in the peripheral region and that the second side edge is located above the side surface of the panel chassis; and
the bezel has at least one aperture opposed to a portion of the second side edge of the film substrate.

2. The display apparatus of claim 1, wherein the film substrate is a right-angled quadrilateral in shape, and the at least one aperture includes two apertures that are opposed to both ends of the second side edge.

3. The display apparatus of claim 1, wherein the at least one aperture is sealed with a transparent member.
